(19) United States
(12) Patent Application Publication
(10) Pub. No.: US 2026/0014474 A1
(43) Pub. Date: Jan. 15, 2026

(54) METHOD AND APPARATUS FOR ENABLING SPEED FEEDBACK MECHANISM, DEVICE AND STORAGE MEDIUM

(71) Applicant: TENCENT TECHNOLOGY (SHENZHEN) COMPANY LIMITED, Shenzhen (CN)

(72) Inventor: Linfeng ZHANG, Shenzhen (CN)

(73) Assignee: TENCENT TECHNOLOGY (SHENZHEN) COMPANY LIMITED, Shenzhen (CN)

(21) Appl. No.: 19/338,358

(22) Filed: Sep. 24, 2025

Related U.S. Application Data
(63) Continuation of application No. PCT/CN2024/100401, filed on Jun. 20, 2024.

(30) Foreign Application Priority Data
Sep. 12, 2023 (CN) 202311176162.6

(51) Int. Cl. A63F 13/58

(52) U.S. Cl. CPC A63F 13/58

(57) ABSTRACT

A method, apparatus, and computer-readable storage medium for enabling speed feedback mechanisms in virtual environments. The method acquires a view ray of a first virtual object that includes an aiming baseline of an associated aiming item. Based on contact conditions between the view ray and multiple moving objects, a first moving object corresponding to the view ray is determined. A speed feedback mechanism is enabled for the first moving object based on the contact condition, featuring an auxiliary aiming mechanism that adjusts the view ray to follow the first moving object according to its movement speed. This approach provides adaptive aiming assistance that responds to target movement dynamics in virtual gaming environments.

### CROSS-REFERENCE TO RELATED APPLICATIONS

This application is a continuation application of International Application No. PCT/CN2024/100401 filed on Jun. 20, 2024 which claims priority to Chinese Patent Application No. 202311176162.6, filed with the China National Intellectual Property Administration on Sep. 12, 2023, the disclosures of each being incorporated by reference herein in their entireties.

### FIELD

The disclosure relates to the technical field of computers, a method and apparatus for enabling a speed feedback mechanism, a device, and a storage medium.

### BACKGROUND

Shooting games refer to all games that include, but are not limited to, first-person shooting games (FPSs), third-person shooting games (TPSs), and the like, and that use firearms to perform ranged attacks.

In the related art, in a shooting game, a player may aim a view ray at a target attack object. When the view ray passes through the target attack object, a movement speed of the target attack object may be proportionally assigned to the view ray of the player, whereby the view ray of the player may move with the movement of the target attack object.

However, when the view ray of the player passes through a plurality of attack objects, an attack object that the view ray may follow may not be determined through the foregoing method, resulting in a low aiming probability.

### SUMMARY

Provided are a method and apparatus for enabling a speed feedback mechanism, a device, a storage medium, and a program product, which can implement enhanced aiming assistance through adaptive view ray adjustment based on moving object speeds in virtual environments.

According to some embodiments, a method for enabling a speed feedback mechanism, performed by a computer device, includes: acquiring a view ray of a first virtual object in a virtual environment, wherein the view ray includes an aiming baseline of an aiming item associated with the first virtual object; determining, based on at least one contact condition between the view ray and a plurality of moving objects, a first moving object corresponding to the view ray from the plurality of moving objects; and enabling a speed feedback mechanism for the first moving object based on a contact condition between the view ray and the first moving object, wherein the speed feedback mechanism comprises an auxiliary aiming mechanism configured to adjust the view ray to follow the first moving object based on a movement speed of the first moving object.

According to some embodiments, an apparatus for enabling a speed feedback mechanism, includes: at least one memory configured to store program code; and at least one processor configured to read the program code and operate as instructed by the program code, the program code including: acquiring code configured to cause at least one of the at least one processor to acquire a view ray of a first virtual object in a virtual environment, wherein the view ray includes an aiming baseline of an aiming item associated with the first virtual object; determining code configured to cause at least one of the at least one processor to determine, based on at least one contact condition between the view ray and a plurality of moving objects, a first moving object corresponding to the view ray from the plurality of moving objects; and enabling code configured to cause at least one of the at least one processor to enable a speed feedback mechanism for the first moving object based on a contact condition between the view ray and the first moving object, wherein the speed feedback mechanism comprises an auxiliary aiming mechanism configured to adjust the view ray to follow the first moving object based on a movement speed of the first moving object.

According to some embodiments, a non-transitory computer-readable storage medium, storing computer code which, when executed by at least one processor, causes the at least one processor to at least: acquire a view ray of a first virtual object in a virtual environment, wherein the view ray includes an aiming baseline of an aiming item associated with the first virtual object; determine, based on at least one contact condition between the view ray and a plurality of moving objects, a first moving object corresponding to the view ray from the plurality of moving objects; and enable a speed feedback mechanism for the first moving object based on a contact condition between the view ray and the first moving object, wherein the speed feedback mechanism comprises an auxiliary aiming mechanism configured to adjust the view ray to follow the first moving object based on a movement speed of the first moving object.

### BRIEF DESCRIPTION OF THE DRAWINGS

FIG. 1 is a schematic diagram of a solution implementation environment according to some embodiments.

FIG. 2 is a flowchart of a method for enabling a speed feedback mechanism according to some embodiments.

FIG. 3 is a schematic diagram of a virtual environment according to some embodiments.

FIG. 4 is a schematic three-dimensional diagram and a schematic plane diagram of a capsule body area according to some embodiments.

FIG. 5 is a schematic diagram of contact conditions between a view ray and a plurality of moving objects according to some embodiments.

FIG. 6 is a schematic flowchart of enabling a speed feedback mechanism according to some embodiments.

FIG. 7 is a schematic flowchart of blocking a speed feedback mechanism according to some embodiments.

FIG. 8 is a schematic diagram of content of a speed feedback mechanism according to some embodiments.

FIG. 9 is a block diagram of an apparatus for enabling a speed feedback mechanism according to some embodiments.

FIG. 10 is a structural block diagram of a computer device according to some embodiments.

### DESCRIPTION OF EMBODIMENTS

Before some embodiments are described, for ease of understanding this solution, terms appearing in this solution are explained below.

1. Virtual environment: referring to an environment displayed (or provided) when an application runs on a terminal device. The virtual environment may be a simulated world of the real world, or may be a semi-simulated semi-fictional three-dimensional world, or may be a purely fictional three-dimensional world. The virtual environment may be any one of a two-dimensional virtual environment, a 2.5-dimensional virtual environment, and a three-dimensional virtual environment. In some embodiments, the virtual environment is further configured for a virtual environment battle between at least two virtual objects, and the virtual environment has virtual resources available to the at least two virtual objects. In some embodiments, the virtual environment includes an open world virtual environment. The virtual environment has at least one level task, and the virtual object may freely select a time and a manner for completing the task.

2. Virtual object: referring to a movable object and an immovable object in a virtual environment. The movable object may be at least one of a virtual object, a virtual animal, and a cartoon character. The immovable object may be at least one of a virtual building, a virtual plant, and a virtual terrain. In one embodiment, when the virtual environment is a three-dimensional virtual environment, the virtual object may be a three-dimensional virtual model. Each virtual object has its own shape and volume in the three-dimensional virtual environment, and occupies a part of space in the three-dimensional virtual environment. In one embodiment, the virtual object is a three-dimensional character built based on a three-dimensional human skeleton technology. The virtual object achieves different external figures by wearing different skins. In some implementations, the virtual object may alternatively be implemented using a 2.5-dimension or 2-dimension model. This is not limited in some embodiments. For example, the virtual object may be divided into a user-controlled virtual object and a server-controlled virtual object according to different manners of controlling the virtual object. The user-controlled virtual object is an object that is movable in the virtual environment and that is controlled by a client. The server-controlled virtual object is a virtual object controlled by an automatic control algorithm or an artificial intelligence (AI) program on the client or the server. The server-controlled virtual object includes a movable object and an unmovable object in the virtual environment. For example, the immovable object may respond to or affect an activity of the movable object. For example, the movable object may destroy the immovable object, or the movable object enters a stealth state when the movable object enters the immovable object. For example, the virtual object in this application is a virtual object controlled by the client. For example, a plurality of virtual objects in this application may be virtual objects controlled by a server.

3. First virtual object: referring to a virtual object whose virtual behaviors may be controlled by a current user terminal using an operation control. In some embodiments, the first virtual object is a virtual object that is movable in a virtual environment. In some embodiments, the first virtual object is a virtual object that is immovable in a virtual environment.

4. Moving object: referring to a virtual object that is movable in a virtual environment, and the moving object is an object that can be aimed at by the first virtual object in the virtual environment. In some embodiments, the moving object refers to another virtual object in the virtual environment other than the first virtual object. In some embodiments, the moving object may be a virtual object controlled by another user terminal, or may be a virtual object controlled by a game system. In some embodiments, the moving object may satisfy two characteristics, capability of moving, and capability of being aimed, and a presentation image (such as a human shape, an animal image, or a plant image) of the moving object is not limited.

5. Aiming item: referring to an item supporting aiming at a moving object. A user controls a first virtual object to use an aiming item to aim at a moving object in a virtual environment. In some embodiments, the aiming item is an attack item having an aiming function, and the attack item is a virtual item having damaging effectiveness on a moving object. For example, if the moving object is attacked by the attack item, health points of the moving object decrease. When the health points of the moving object decrease to 0, the moving object is killed, and further disappears from the virtual environment. In some embodiments, the attack item may alternatively be referred to as a shooting item.

In some embodiments, the aiming item is an exposure type item having an aiming function. When the moving object is aimed at by the exposure type item, a position of the moving object is synchronously exposed to a terminal image of a teammate virtual object.

In some embodiments, the aiming item is an interactive item having an aiming function. When the moving object is aimed at by the interactive item, the interactive item transmits an interactive flying object to the moving object. For example, when the interactive item is a tennis racket, the moving object is a virtual opponent object, and when the virtual opponent object is aimed at, the tennis racket hits a tennis ball towards the virtual opponent object.

6. View ray: referring to an aiming baseline of an aiming item. The aiming baseline is a ray configured to assist the aiming item to aim. In some embodiments, the aiming item is an attack item, and the aiming baseline refers to a ray that uses an attack port of the attack item as an endpoint and points to an attack direction of the attack item. For example, if the aiming item is a virtual arrow, the aiming baseline refers to a ray that uses an arrow of the virtual arrow as the endpoint and that points to a shooting direction of the virtual arrow.

In some embodiments, the endpoint of the aiming baseline may alternatively be any point on the first virtual object, for example, eyes of the first virtual object, or any point on the aiming item, for example, a sighting device of the aiming item (in some embodiments, an aiming scope on a shooting item).

7. Speed feedback mechanism: referring to a mechanism in which a view ray moves with movement of a first moving object, and being configured for assisting the view ray in aiming at the first moving object. A movement speed of the view ray is determined according to a movement speed of the first moving object, and generally, the movement speed of the first moving object is proportionally assigned to the view ray according to a speed feedback coefficient.

8. Outer capsule body: referring to a capsule body surrounding a moving object. For example, the moving object is located in an outer capsule body, and the outer capsule body is configured with capsule body parameters such as a radius, a half-height, a position, and a rotation, which are configured for representing a size and position movement of the outer capsule body. In some embodiments, the outer capsule body may be a capsule body centering on a central axis of a moving object, or may be a capsule body not centering on a central axis of a moving object.

9. Inner capsule body: referring to a capsule body in a contour area of a moving object. For example, the inner capsule body is located in the moving object, and the inner capsule body is configured with capsule body parameters such as a radius, a half-height, a position, and a rotation, which are configured for representing a size and position movement of the inner capsule body. In some embodiments, the inner capsule body may be a capsule body centering on a central axis of a moving object, or may be a capsule body not centering on a central axis of a moving object.

10. Contour area: referring to a three-dimensional space area corresponding to a body of a moving object.

11. Capsule body area: referring to a three-dimensional interlayer area between an inner capsule body and an outer capsule body.

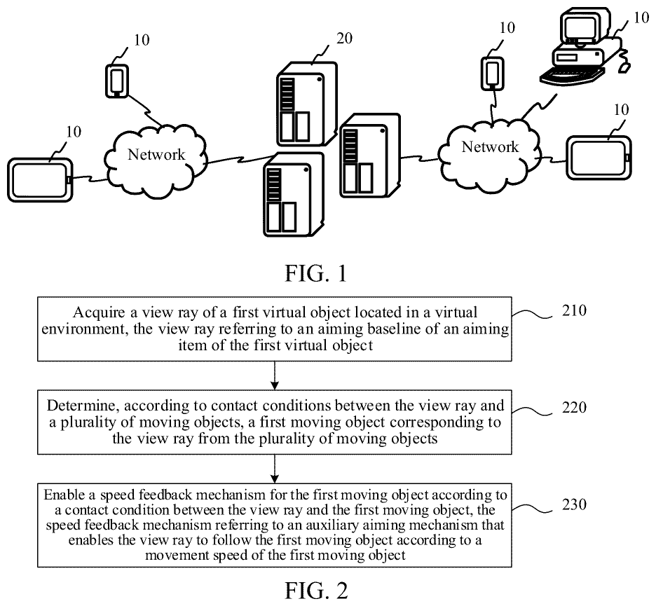

FIG. 1 is a schematic diagram of a solution implementation environment according to some embodiments. The solution implementation environment may be implemented as a system for enabling a speed feedback mechanism. The solution implementation environment may include a terminal device 10 and a server 20.

One or more terminal devices 10 may be provided. The terminal device 10 may be an electronic device such as a mobile phone, a tablet computer, a game console, an e-book reader, a multimedia playback device, a wearable device, a personal computer (PC), and an on-board terminal. A client of a target application (for example, a game application) may be installed in the terminal device 10. In some embodiments, the target application may be an application that may be downloaded and installed, or may be a click-to-use application. This is not limited in some embodiments.

In some embodiments, the target application may be a game application, including a shooting application, a racing application, a multiplayer online tactical arena game, and the like. This is not limited in some embodiments. In some embodiments, the foregoing game application may be a shooting application. The shooting application can provide a virtual environment for a virtual object that a user substitutes for and operates to perform an activity in the virtual environment, such as walking and shooting. Typically, the shooting application may be any application having a function of shooting a product, such as a TPS, a FPS, a multiplayer online battle arena (MOBA) game, a multiplayer gunfight survival game, a virtual reality (VR) shooting application, an augmented reality (AR) application, a three-dimensional map program, a social application, or an interactive entertainment application. In addition, for different applications, forms or shapes of virtual objects provided by the applications may alternatively be different, and corresponding functions may alternatively be different. These may be designed according to actual requirements. This is not limited in some embodiments. In some embodiments, a client of the foregoing application runs in the terminal device 10. In some embodiments, the foregoing application is an application developed based on a three-dimensional virtual environment engine. For example, the virtual environment engine is a unity engine. The virtual environment engine can construct a three-dimensional virtual environment, a virtual object, a virtual item, and the like, which brings more immersive game experience to a user.

The foregoing virtual environment refers to a scene created for the virtual object to perform activities (for example, game competition), for example, a virtual house, a virtual island, or a virtual map.

The foregoing virtual object refers to a virtual object, a virtual vehicle, a virtual article, or the like controlled by a user account in a target application. This is not limited in some embodiments. Using the target application being the game application as an example, the virtual object refers to a game character controlled by a user account in the game application. The virtual object may be in a human form, an animal form, a cartoon form, or another form. This is not limited in some embodiments. In some embodiments, the virtual object is a virtual vehicle in a virtual environment, for example, a virtual item that can be controlled by a user, such as a virtual car, a virtual hot balloon, or a virtual motorcycle.

The server 20 is configured to provide a background service for the client of the target application installed and running on the terminal device 10. For example, the server 20 may be a background server of the foregoing game application. The server 20 may be one server, or may be a server cluster including a plurality of servers, or a cloud computing service center. In some embodiments, the server 20 provides background services for the target application in a plurality of terminal devices 10 simultaneously. The terminal device 10 may communicate with the server 20 through a network.

In some embodiments, operations may be performed by a computer device. The computer device refers to an electronic device having data computing, processing, and storage functions. For example, the computer device may be a terminal device 10 shown in FIG. 1, or may be a server 20.

In some embodiments, after a first virtual object corresponding to a user account enters a virtual environment, a game reward is obtained by attacking a moving object, and the moving object refers to an object movable in the virtual environment. The computer device may control an attack behavior of the first virtual object through an intelligent algorithm, and enables a speed feedback mechanism for a target moving object after meeting an enabling requirement of the speed feedback mechanism for the target moving object, whereby a view ray of the first virtual object may automatically follow the target moving object according to a movement speed of the target moving object, a probability that an aiming item aims at the target moving object is increased, and further, when the aiming item is a shooting item having an aiming function, a probability that the shooting item hits the target moving object is increased.

In some embodiments, the moving object may be a virtual object with a relatively large contour area, for example, a virtual object in a cartoon form or an animal form. In this case, a range of an area in which the moving object may be attacked is relatively large. In addition, an action amplitude of such a moving object is relatively small, and a movement speed of a limb is relatively low, which is prone to causing a situation that a plurality of moving objects are very close to each other, or a plurality of moving objects overlap each other. A suitable method for enabling a speed feedback mechanism may be used for various situations. In addition, different styles of game applications bring different experiences to users and has requirements on user operations. Therefore, the speed feedback mechanism provided in some embodiments may be applicable to different game applications.

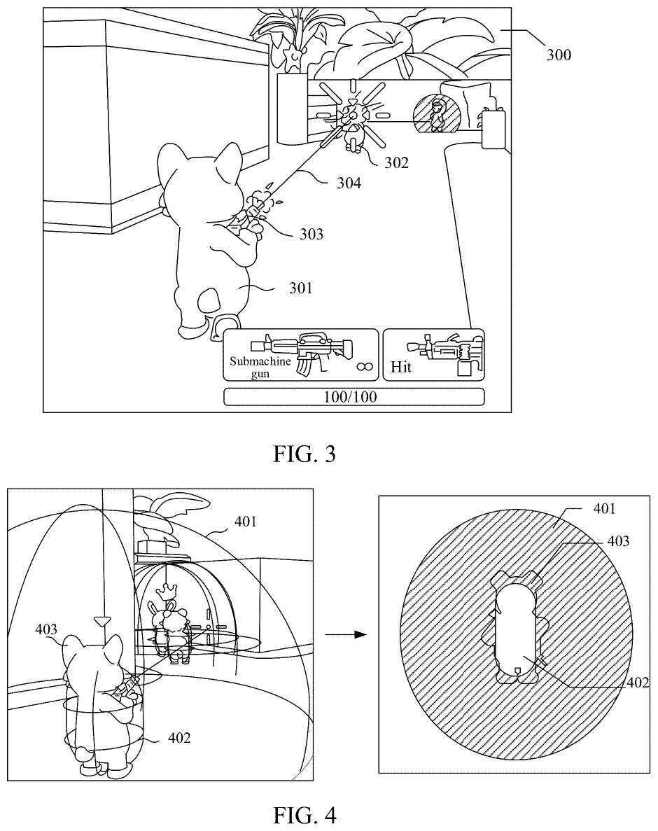

FIG. 2 is a flowchart of a method for enabling a speed feedback mechanism according to some embodiments. Each operation of the method may be performed by a computer device. The method may include at least one operation of operation 210 to operation 230 below.

Operation 210: Acquire a view ray of a first virtual object located in a virtual environment, the view ray referring to an aiming baseline of an aiming item of the first virtual object.

The virtual environment includes a first virtual object and a plurality of moving objects. The first virtual object refers to a virtual object whose virtual behaviors may be controlled by a current user terminal using an operation control. In some embodiments, the first virtual object is a virtual object that is movable in a virtual environment. In some embodiments, the first virtual object is a virtual object that is immovable in a virtual environment.

The moving object refers to a virtual object that is movable in a virtual environment, and the moving object is an object that can be aimed at by the first virtual object in the virtual environment. In some embodiments, the moving object refers to another virtual object in the virtual environment other than the first virtual object. In some embodiments, the moving object may be a virtual object controlled by another user terminal, or may be a virtual object controlled by a game system. In some embodiments, the moving object may satisfy two characteristics, capability of moving, and capability of being aimed, and a presentation image (such as a human shape, an animal image, or a plant image) of the moving object is not limited.

The aiming item is an item supporting aiming at a moving object. A user may control the first virtual object to use an aiming item to aim at a moving object in a virtual environment. In some embodiments, the aiming item is an attack item having an aiming function, and the attack item is a virtual item having damaging effectiveness on a moving object. For example, if the moving object is attacked by the attack item, health points of the moving object decrease. When the health points of the moving object decrease to 0, the moving object is killed, and further disappears from the virtual environment.

When the target application is a shooting application, the attack item may refer to a shooting item, which includes, but is not limited to, a virtual arrow, and the like. For example, if the attack item is a virtual arrow, the user controls the first virtual object to operate the virtual arrow, whereby a string of the virtual arrow releases an arrow to attack an attack object.

In some embodiments, the aiming item is an exposure type item having an aiming function. When the moving object is aimed at by the exposure type item, a position of the moving object is synchronously exposed to a terminal image of a teammate virtual object.

In some embodiments, the aiming item is an interactive item having an aiming function. When the moving object is aimed at by the interactive item, the interactive item transmits an interactive flying object to the moving object. For example, when the interactive item is a tennis racket, the moving object is a virtual opponent object, and when the virtual opponent object is aimed at, the tennis racket hits a tennis ball towards the virtual opponent object.

The view ray refers to an aiming baseline of an aiming item of a first virtual object, and the aiming baseline is a ray configured for assisting the aiming item to perform aiming. In some embodiments, the aiming item is an attack item, and the aiming baseline refers to a ray that uses an attack port of the attack item as an endpoint and points to an attack direction of the attack item. For example, if the aiming item is a virtual arrow, the aiming baseline refers to a ray that uses an arrow of the virtual arrow as the endpoint and that points to a shooting direction of the virtual arrow.

In some embodiments, the endpoint of the aiming baseline may alternatively be any point on the first virtual object, for example, eyes of the first virtual object, or any point on the aiming item, for example, a sighting device of the aiming item (an aiming scope on a shooting item).

A pointing position of the view ray is not limited, and the pointing position of the view ray may be a body part of the moving object, or may be any body part of the moving object, for example, may point to any body part such as a head, a thorax, or limbs of the moving object. A pointing position may be automatically set according to an actual aiming requirement.

When the view ray is in contact with a sample object, a crosshair is formed on the object. The crosshair is configured for indicating an aiming point of the aiming item. Generally, a target object of the view ray is a moving object. As shown in FIG. 3, the aiming item is an attack item. A virtual environment 300 includes a first virtual object 301 and a moving object 302. The first virtual object 301 holds an attack item 303. An aiming baseline 304 of the attack item 303 points to the moving object 302, and forms a crosshair on the moving object 302 as an attack point of the attack item 303 of the first virtual object 301.

Operation 220: Determine, according to contact conditions between the view ray and a plurality of moving objects, a first moving object corresponding to the view ray from the plurality of moving objects.

The first moving object is a target moving object that currently may be aimed at by the first virtual object.

In some embodiments, a capsule body area is disposed around the moving object, and the capsule body area is a three-dimensional interlayer area between an inner capsule body and an outer capsule body. The outer capsule body is a three-dimensional space area surrounding the inner capsule body, and the moving object is located in the outer capsule body.

The capsule body area is a three-dimensional interlayer area between the inner capsule body and the outer capsule body. The outer capsule body is a capsule body that can surround a moving object. For example, the moving object is located in the outer capsule body. The inner capsule body is a small capsule body inside the outer capsule body. For example, the inner capsule body is located in the outer capsule body. A contour area of the moving object refers to a three-dimensional space area corresponding to a body of the moving object. In some embodiments, the inner capsule body is located in a contour area of the moving object. In some embodiments, the inner capsule body may be a capsule body surrounding the contour area of the moving object, or may be a capsule body in which a part of the capsule body area overlaps the contour area of the moving object.

The inner capsule body and the outer capsule body are configured with capsule body parameters, such as a radius, a half-height, a position, and a rotation, which are configured for representing a size and position movement of the inner capsule body and the outer capsule body. In some embodiments, the inner capsule body and the outer capsule body may be both capsule bodies centering on a central axis of a moving object, or may be capsule bodies not centering on a central axis of a moving object.

FIG. 4 shows a schematic three-dimensional diagram and a schematic plane diagram of a capsule body area. An inner capsule body 402 and an outer capsule body 401 are both capsule bodies centering on a central axis of a moving object. The capsule body area is a three-dimensional interlayer area between the inner capsule body 402 and the outer capsule body 401. Details may refer to a gray area part in the schematic plane diagram shown in FIG. 4. The contour area 403 of the moving object refers to a three-dimensional space area corresponding to a body of the moving object. The contour area 403 and the inner capsule body 402 in FIG. 4 have part capsule body areas overlapping with each other.

In some embodiments, a moving object of the plurality of moving objects that has a smallest distance to the first virtual object is determined as the first moving object in a case that the view ray is in contact with the contour areas of the plurality of moving objects, the contour area of the moving object referring to a three-dimensional space area corresponding to the body of the moving object.

A case that the view ray is in contact with the contour area of the moving object means that the view ray is in contact with a body area of the moving object, in some embodiments, may mean that the view ray is in contact with an edge of the body area of the moving object, or may mean that the view ray passes through the body area of the moving object. A moving object of the plurality of moving objects that has a smallest distance to the first virtual object is determined as the first moving object in a case that the view ray is in contact with body areas of the plurality of moving objects.

In some embodiments, for each of the plurality of moving objects, a position of the first virtual object in a virtual environment, and positions of the plurality of moving objects in the virtual environment are acquired. Distances between the first virtual object and the plurality of moving objects are respectively calculated according to the position of the first virtual object and the positions of the plurality of moving objects; and the moving object of the plurality of moving objects that has the smallest distance to the first virtual object is determined as the first moving object.

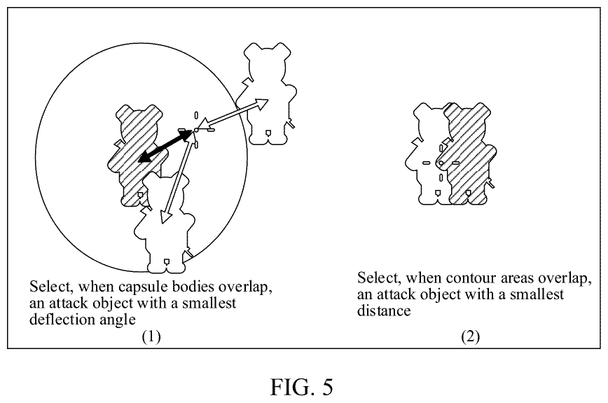

As shown in FIG. 5, (2) in FIG. 5 shows a case that a view ray is in contact with contour areas of a plurality of moving objects. It can be learned that a crosshair of the view ray points to body areas of two moving objects. Distances between the first virtual object and the two moving objects are separately calculated, to select a moving object having the smallest distance to the first virtual object as the first moving object, for example, a moving object indicated by a gray area in (2) in FIG. 5 is selected as the first moving object.

In some embodiments, a moving object of the plurality of moving objects that has a smallest deflection angle relative to the view ray is determined as the first moving object in a case that the view ray is in contact with outer capsule bodies of the plurality of moving objects and not in contact with a contour area of any moving object.

In some embodiments, a case that the view ray is in contact with the outer capsule body of the moving object may refer to the view ray being in contact with an edge of the outer capsule body of the moving object or the view ray passing through the outer capsule body of the moving object.

A case that the view ray is in contact with the outer capsule bodies of the plurality of moving objects and not in contact with the contour area of any moving object refers to a case that there are a plurality of moving objects. The plurality of moving objects herein indicate moving objects whose outer capsule bodies are in contact with the view ray and contour areas are not in contact with the view ray.

The deflection angle of the moving object relative to the view ray is an included angle between a connecting line between the moving object and the first virtual object and the view ray of the first virtual object, and is configured for representing a deflection distance of the moving object relative to the view ray. The moving object of the plurality of moving objects that has the smallest deflection angle relative to the view ray is determined as the first moving object.

According to a contact condition between a view ray and a plurality of moving objects, for different contact conditions, a corresponding manner of determining the first moving object is selected, whereby a finally selected moving object is a moving object that is easier to be aimed at by the first virtual object controlled by a user, crosstalk during overlapping of a plurality of targets is avoided, and aiming precision of aiming at the moving object by the user is improved. When the aiming item is an attack item, a success rate of killing the moving object by the user can be improved.

In some embodiments, for each of the plurality of moving objects, a ray pointing to the moving object from an endpoint of a view ray is acquired to obtain a connecting ray corresponding to the moving object. A deflection angle of the moving object relative to the view ray is obtained according to an included angle between the view ray and the connecting ray corresponding to the moving object. The moving object that has the smallest deflection angle is determined as the first moving object.

The connecting ray corresponding to the moving object indicates a ray direction to which the view ray of the first virtual object points. The ray pointing from an endpoint of the view ray to the moving object may refer to a ray pointing from the endpoint of the view ray to any body part of the moving object, for example, may be a ray pointing from the endpoint of the view ray to any body part such as a head, a thorax, and limbs of the moving object. This is not limited in this application and may be automatically set according to an actual aiming requirement.

An included angle between the view ray and the connecting ray corresponding to each moving object is obtained according to the view ray and the connecting ray corresponding to each moving object. The included angle is used as the deflection angle of the moving object relative to the view ray. The deflection angle may indicate an angle that may be deflected from a current pointing direction of the view ray to a ray direction to which the view ray points. The moving object that has the smallest angle that may be deflected is determined as the first moving object.

As shown in FIG. 5, (1) in FIG. 5 shows a case that a view ray is in contact with outer capsule bodies of a plurality of moving objects. It can be learned that a crosshair of the view ray falls into the outer capsule bodies of the three moving objects, for example, a pointing direction of the view ray passes through the outer capsule bodies of the three moving objects, deflection angles between the view ray of the first virtual object and connecting rays respectively corresponding to the three moving objects are separately calculated, to select a moving object that has the smallest deflection angle as the first moving object, for example, a moving object indicated by a gray area in (1) in FIG. 5 is selected as the first moving object.

The deflection angle of the moving object relative to the view ray is used as a reference condition for determining the first moving object, and the moving object that has the smallest deflection angle is determined as the first moving object, whereby an angle of the view ray of the first virtual object that may be deflected is the smallest, time for aiming at the moving object is shortened, and efficiency of aiming at the moving object is improved.

In some embodiments, in a case that the view ray is in contact with contour areas of a part of moving objects of the plurality of moving objects, and the view ray is in contact with outer capsule bodies of the other part of moving objects and not in contact with contour areas of the other part of moving objects, the first moving object is determined from the part of moving objects.

Schematically, in the plurality of moving objects, the contour areas of the part of moving objects are in contact with the view ray, non-contour areas (areas of non-contour areas in the outer capsule bodies) of the other part of moving objects are in contact with the view ray, and the first moving object is determined from the part of moving objects whose contour areas are in contact with the view ray. Each of the two parts of moving objects may include one moving object or a plurality of moving objects. With reference to FIG. 5, when cases in (1) and (2) in FIG. 5 simultaneously occur, the case in (2) is preferentially considered.

Operation 230: Enable a speed feedback mechanism for the first moving object according to a contact condition between the view ray and the first moving object, the speed feedback mechanism referring to an auxiliary aiming mechanism that enables the view ray to follow the first moving object according to a movement speed of the first moving object.

After the first moving object corresponding to the view ray is determined according to contact conditions between the view ray and a plurality of moving objects, whether to enable the speed feedback mechanism for the first moving object is determined according to the contact condition between the view ray and the first moving object.

The speed feedback mechanism is an automatic movement mechanism of the view ray, refers to a mechanism in which the view ray moves with movement of the first moving object, and is configured for assisting the view ray in aiming at the first moving object. A movement speed of the view ray is determined according to a movement speed of the first moving object, and generally, the movement speed of the first moving object is proportionally assigned to the view ray according to a speed feedback coefficient.

After the speed feedback mechanism for the first moving object is enabled, the view ray automatically moves with movement of the first moving object, and an actual movement speed of the view ray includes an automatic following speed of the view ray and an input speed of inputting a user operation. The speed feedback mechanism enables the view ray to automatically follow the first moving object, to help the user to aim at, whereby a probability that the view ray aims at the first moving object can be improved after the user operation.

In some embodiments, a speed feedback mechanism for the first moving object is enabled in a case that the view ray is not in contact with an inner capsule body of the first moving object.

In some embodiments, the view ray not in contact with the inner capsule body of the moving object may refer to that the view ray is not in contact with an inner portion and an edge of the inner capsule body of the moving object.

The speed feedback mechanism for the first moving object is enabled in a case that the view ray is not in contact with the inner capsule body of the first moving object; and the speed feedback mechanism for the first moving object is not enabled in a case that the view ray is in contact with the inner capsule body of the first moving object.

The speed feedback mechanism for the first moving object is enabled in a case that the view ray is not in contact with the inner capsule body of the first moving object, which indicates that there is still a distance between the view ray and the first moving object. The speed feedback mechanism may be enabled to help the view ray aim at the first moving object, whereby a probability that the view ray aims at the first moving object. However, the speed feedback mechanism for the first moving object is not enabled in a case that the view ray is in contact with the inner capsule body of the first moving object, which indicates that the view ray has already aimed at the first moving object, or the distance between the view ray and the first moving object is extremely small. The user may directly hit the first moving object in this case. Therefore, the speed feedback mechanism does not may be additionally enabled, and computing resources of the computer device are reduced.

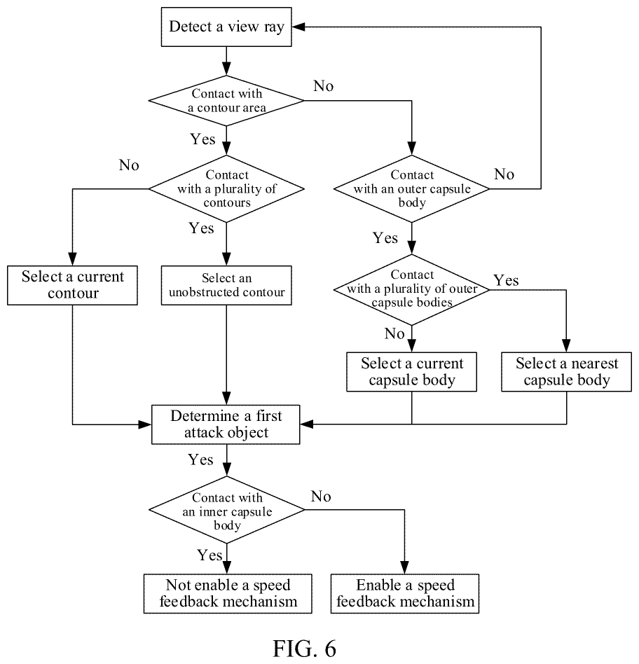

FIG. 6 is a schematic flowchart of enabling a speed feedback mechanism. First, a view ray of a first virtual object is detected, and whether the view ray is in contact with a contour area of a moving object is determined. A quantity of contour areas that are in contact with the view ray is determined in a case that the view ray is in contact with the contour area of at least one moving object. A moving object corresponding to the contour area is determined as a first moving object in a case that the view ray is in contact with the contour area of the moving object. In a case that the view ray is in contact with contour areas of the plurality of moving objects, a moving object of the plurality of moving objects that has a smallest distance to the first virtual object is determined as a first moving object, for example, the moving object whose contour area is not obstructed by other moving objects is selected as the first moving object.

Whether the view ray is in contact with an outer capsule body of at least one moving object in a case that the view ray is not in contact with a contour area of any moving object. The view ray continues to be detected at a next moment if the view ray is not in contact with the outer capsule body of any moving object. A quantity of the outer capsule bodies in contact with the view ray is determined if the view ray is in contact with the outer capsule body of at least one moving object. A moving object corresponding to the outer capsule body is determined as a first moving object if the view ray is in contact with the outer capsule body of the moving object; and a moving object of the plurality of moving objects that has a smallest deflection angle relative to the view ray is determined as a first moving object if the view ray is in contact with the outer capsule bodies of the plurality of moving objects, for example, a moving object with a closest distance from the view ray to the moving object is selected as the first moving object.

Whether the view ray is in contact with an inner capsule body of the first moving object is determined after the first moving object that currently may be aimed at by the view ray is determined. The speed feedback mechanism for the first moving object is enabled if the view ray is not in contact with the inner capsule body of the first moving object; and the speed feedback mechanism for the first moving object is not enabled if the view ray is in contact with the inner capsule body of the first moving object.

In the technical solutions provided in some embodiments, the view ray of the first virtual object located in the virtual environment is acquired, and the first moving object corresponding to the view ray is determined from the plurality of moving objects according to the contact conditions between the view ray and the plurality of moving objects. Thus, for different contact conditions, a moving object that is more easily aimed at by the first virtual object may be selected in different selection manners, thereby avoiding crosstalk during overlapping of a plurality of targets, and increasing a success rate of aiming at the first moving object by a user. In addition, the speed feedback mechanism for the first moving object is enabled according to the contact condition between the view ray and the first moving object, whereby the view ray may move with the movement of the first moving object to assist the user in aiming at the first moving object, thereby improving a probability of aiming at the first moving object by the view ray, and further increasing the success rate of aiming at the first moving object by the user.

After operation 230, at least one of operation 240 and operation 250 (not shown in the figure) is further included.

Operation 240: Determine a speed feedback coefficient according to a deflection angle of the first moving object relative to the view ray and a distance between the first moving object and the first virtual object, the speed feedback coefficient referring to a ratio of the movement speed of the view ray to the movement speed of the first moving object, and the speed feedback coefficient having a positive correlation with the deflection angle and having a negative correlation with the distance; and determine a movement speed of the view ray according to the speed feedback coefficient and the movement speed of the first moving object.

The speed feedback coefficient is configured for indicating a ratio of the movement speed of the view ray to the movement speed of the first moving object. The speed feedback coefficient may be any value from 0 to 1, for example, the movement speed of the view ray is less than or equal to the movement speed of the first moving object.

A magnitude of the speed feedback coefficient is related to the deflection angle of the first moving object relative to the view ray and the distance between the first moving object and the first virtual object. The speed feedback coefficient has a positive correlation with the deflection angle, and has a negative correlation with the distance. For example, a larger deflection angle of the first moving object relative to the view ray indicates a larger speed feedback coefficient, and a smaller deflection angle of the first moving object relative to the view ray indicates a smaller speed feedback coefficient. A larger distance between the first moving object and the first virtual object indicates a smaller speed feedback coefficient, and a smaller distance between the first moving object and the first virtual object indicates a larger speed feedback coefficient.

In some embodiments, impact degree of the deflection angle and the distance on the speed feedback coefficient is not limited. In some embodiments, it may be that impact degree of the deflection angle on the speed feedback coefficient is greater than impact degree of the distance on the speed feedback coefficient. For example, impact of the deflection angle on the speed feedback coefficient is to be preferentially considered if the impact of the deflection angle on the speed feedback coefficient conflicts with the impact of the distance on the speed feedback coefficient. For example, the speed feedback coefficient increases in a case that the deflection angle of the first moving object relative to the view ray increases, and the distance between the first moving object and the first virtual object increases; and the speed feedback coefficient decreases in a case that the deflection angle of the first moving object relative to the view ray decreases, and the distance between the first moving object and the first virtual object decreases.

In some embodiments, the impact degree of the deflection angle on the speed feedback coefficient may alternatively be less than the impact degree of the distance on the speed feedback coefficient. For example, impact of the distance on the speed feedback coefficient is to be preferentially considered if the impact of the deflection angle on the speed feedback coefficient conflicts with the impact of the distance on the speed feedback coefficient. For example, the speed feedback coefficient decreases in a case that the deflection angle of the first moving object relative to the view ray increases, and the distance between the first moving object and the first virtual object increases. The speed feedback coefficient increases in a case that the deflection angle of the first moving object relative to the view ray decreases, and the distance between the first moving object and the first virtual object decreases.

The speed feedback coefficient refers to a ratio of the movement speed of the view ray to the movement speed of the first moving object. Therefore, the movement speed of the view ray may be determined according to the speed feedback coefficient and the movement speed of the first moving object. The movement speed of the view ray=the movement speed of the first moving object×the speed feedback coefficient. The movement speed of the view ray herein refers to an automatic following speed of the view ray for the first moving object, and an actual movement speed of the view ray includes the automatic following speed of the view ray and an input speed of inputting a user operation.

The speed feedback coefficient is determined according to the deflection angle of the first moving object relative to the view ray and the distance between the first moving object and the first virtual object, whereby the speed feedback coefficient may be dynamically adjusted according to a relative condition between the first moving object and the first virtual object, the view ray can better follow movement of the first moving object, and a probability that the view ray aims at the first moving object is improved.

In some embodiments, in a case that the deflection angle increases, the movement speed of the view ray is determined according to the movement speed of the first moving object, the speed feedback coefficient, and the attenuation coefficient, the attenuation coefficient being a speed adjustment coefficient for a case that the deflection angle increases.

The attenuation coefficient is a preset coefficient. The attenuation coefficient does not change as the deflection angle increases in a case that the deflection angle increases. The value of the attenuation coefficient may be any value from 0 to 1, or may be a value greater than 1. The value of the attenuation coefficient is not limited in this application, and may be set according to an actual speed feedback requirement.

The attenuation coefficient is configured for further adjusting the movement speed of the view ray in a case that the deflection angle increases. For example, the attenuation coefficient may be a value greater than 1, which indicates that the attenuation coefficient is configured for preventing the view ray from not following the first moving object in a case that the first moving object moves away from the view ray of the first virtual object. The attenuation coefficient may be a value from 0 to 1, which indicates that the attenuation coefficient is configured for reducing a movement speed of the view ray in a case that the first moving object moves away from the view ray of the first virtual object, and another moving object may be selected as the target moving object instead of the first moving object.

When the deflection angle decreases, the movement speed of the view ray is determined according to the speed feedback coefficient and the movement speed of the first moving object, where the movement speed of the view ray=the movement speed of the first moving object×the speed feedback coefficient.

The movement speed of the view ray is determined according to the movement speed of the first moving object, the speed feedback coefficient, and the attenuation coefficient in a case that the deflection angle increases, where the movement speed of the view ray=the movement speed of the first moving object×the speed feedback coefficient×the attenuation coefficient.

The movement speed of the view ray is further limited by setting the attenuation coefficient in a case that the deflection angle increases, whereby the view ray may better follow movement of the target moving object in a case that the deflection angle increases.

Operation 250: Determine, in a case that the deflection angle of the first moving object relative to the view ray continuously increases until the deflection angle is greater than a first threshold, the first moving object as a blocking object, the blocking object being a moving object that the speed feedback mechanism is invalid within a blocking time.

The blocking object refers to a moving object that the speed feedback mechanism is temporarily not invalid for the moving object within the blocking time. The blocking time is a preset value, for example, a length of the blocking time is irrelevant to the value of the first threshold. Values of the blocking time and the first threshold are not limited in this application, and may be automatically set according to an actual speed feedback requirement.

In a case that the deflection angle of the first moving object relative to the view ray continuously increases until the deflection angle is greater than the first threshold, the first moving object is temporarily added to a blocking list, whereby the speed feedback mechanism is temporarily invalid for the first moving object within the blocking time, to avoid resource waste caused by the fact that the view ray still follows when the first moving object is about to break away from following of the view ray. The view ray may detect another moving object within the blocking time, to determine whether there is a moving object for which the speed feedback mechanism is more necessary to be enabled in the virtual environment, thereby accelerating a game process, and moreover, improving efficiency of aiming the moving object.

In some embodiments, blocking for the first moving object is released in a case that the blocking time ends; or blocking for the first moving object is released in a case that a speed feedback mechanism for a second moving object is enabled.

Releasing the blocking for the first moving object refers to that the speed feedback mechanism may be invalid for the first moving object again, but does not indicate that the speed feedback mechanism for the first moving object has been simultaneously enabled when the blocking for the first moving object is released, and indicates that the first moving object may be added to a detection list when the view ray detects. The first moving object has a possibility of being determined as the target moving object again.

In some embodiments, if the view ray detects another moving object within the blocking time and a speed feedback mechanism for the another moving object is not enabled, the blocking for the first moving object is released in a case that the blocking time ends.

After the blocking for the first moving object is released, each moving object may be detected. A target moving object corresponding to the view ray is determined again according to contact conditions between the view ray and a plurality of moving objects at a moment of releasing the blocking, and whether to enable a speed feedback mechanism for the target moving object is determined. Therefore, after the blocking for the first moving object is released, the speed feedback mechanism for the first moving object may be enabled, the speed feedback mechanism for the another moving object may be enabled, or a speed feedback mechanism for any moving object may not be enabled.

In some embodiments, if the view ray detects another moving object within the blocking time within the blocking time and the speed feedback mechanism for another moving object is enabled, the blocking for the first moving object is released in a case that a speed feedback mechanism for a second moving object is enabled.

The second moving object is another moving object different from the first moving object. The second moving object is a target moving object that is determined from the plurality of moving objects and that corresponds a view ray according to contact conditions between the view ray and the plurality of moving objects in a case that the second moving object is a moving object except the first moving object. Moreover, the view ray is not in contact with an inner capsule body of the second moving object.

After the first moving object is determined as the blocking object, a contact condition between the view ray and another moving object is detected to determine whether another moving object meeting a condition for enabling a speed feedback mechanism exists in the virtual environment, to transfer a target moving object, which can accelerate a game process, follow the second moving object meeting the condition for enabling the speed feedback mechanism, and is beneficial to improving efficiency of aiming at the moving object.

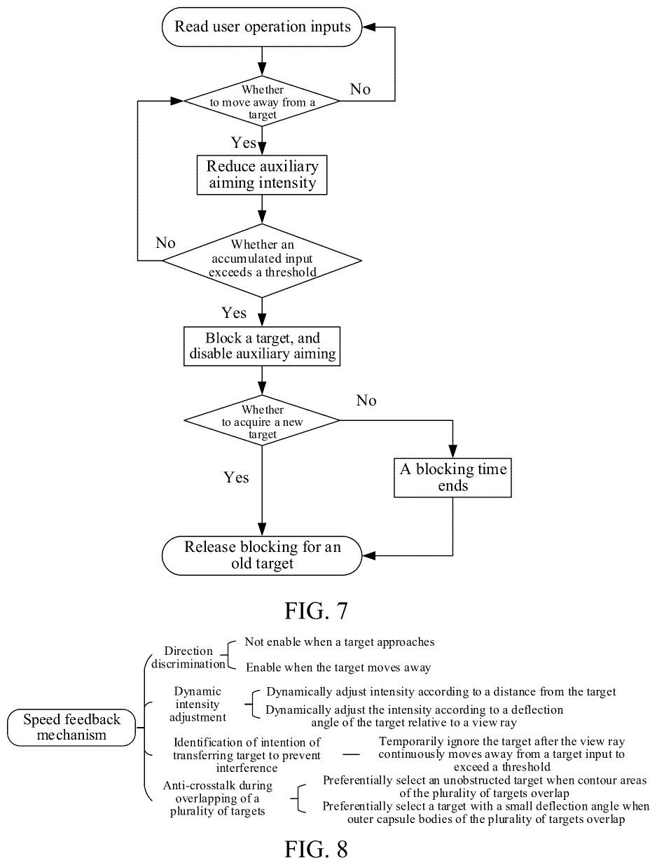

FIG. 7 is a schematic flowchart of blocking a speed feedback mechanism according to some embodiments. First, user operation inputs are read, a view ray of a first virtual object and a connecting ray corresponding to a target moving object are acquired, and whether the view ray moves away from the target moving object is determined according to a deflection angle of the target moving object relative to the view ray. The user operation input continues to be acquired at a next moment, and the view ray is determined if the view ray is not away from the target moving object. If the view ray moves away from the target moving object, auxiliary aiming intensity will be reduced according to an attenuation coefficient, for example, an automatic following speed of the view ray is reduced.

Whether the deflection angle of the target moving object relative to the view ray continuously increases and is greater than a first threshold is determined. Whether the view ray moves away from the target moving object is continuously determined at a next moment if the deflection angle of the target moving object relative to the view ray does not continuously increase, or the continuously increased deflection angle does not exceed a first threshold. In a case that the deflection angle of the target moving object relative to the view ray continuously increases until the deflection angle is greater than the first threshold, the target moving object is determined as a blocking object, and a speed feedback mechanism for the target moving object is temporarily closed within a blocking time.

Within the blocking time, a contact condition between the view ray and another moving object is determined. Blocking for an old target moving object is directly released if a speed feedback mechanism for a new target moving object is enabled within the blocking time. The blocking for the old target moving object is released after the blocking time ends if the speed feedback mechanism for the new target moving object is not enabled within the blocking time.

The following describes some embodiments.

In some embodiments, in a case that a view ray is in contact with a capsule body area of a third moving object, a speed feedback mechanism for the third moving object is enabled.

In a case that a view ray is in contact with a capsule body area of a moving object, a speed feedback mechanism for the moving object is enabled. The third moving object is a moving object whose capsule body area is in unique contact with the view ray in a virtual environment. The third moving object may be either of the first moving object and the second moving object, or may be a moving object different from both of the first moving object and the second moving object. This is not limited in this application.

A speed feedback mechanism for a moving object is enabled in a case that a capsule body area of only one moving object is in contact with the view ray, whereby there is no trouble caused by overlapping of a plurality of targets, computing resources of a computer device are reduced, and game running efficiency is improved.

In some embodiments, the speed feedback mechanism for the third moving object is disabled in a case that the view ray is in contact with an inner capsule body of the third moving object or not in contact with an outer capsule body of the third moving object.

After the speed feedback mechanism for the third moving object is enabled, the speed feedback mechanism for the third moving object is disabled in a case that the view ray is in contact with the inner capsule body of the third moving object or is not in contact with the outer capsule body of the third moving object, for example, in a case that a deflection angle of the third moving object relative to the view ray decreases until the view ray is in contact with the inner capsule body of the third moving object, or the deflection angle increases until the view ray is no longer in contact with the outer capsule body of the third moving object.

For example, a state of enabling the speed feedback mechanism for the third moving object can be kept only when the view ray is in contact with the capsule body area of the third moving object.

The foregoing conditions for enabling and disabling the speed feedback mechanism may alternatively be applied to a case that the view ray is in contact with the first moving object.

The speed feedback mechanism for the third moving object is disabled in a case that the view ray is in contact with the inner capsule body of the third moving object, which reduces computing resources of a computer device. A user operation may directly attack the third moving object without a speed feedback mechanism if the view ray is in contact with the inner capsule body of the third moving object. The speed feedback mechanism for the third moving object is disabled in a case that the view ray is not in contact with the outer capsule body of the third moving object, which indicates that a probability that the view ray aims at the third moving object is relatively low, and another moving object may be selected for aiming, thereby not only reducing computing resources of a computer device, but also improving efficiency of aiming at the moving object.

The following describes some embodiments.

In some embodiments, in a case that a deflection angle of a fourth moving object relative to a view ray increases, a speed feedback mechanism for the fourth moving object is enabled.

The speed feedback mechanism for the fourth moving object is enabled in a case that the view ray is in contact with the capsule body area of the fourth moving object and the deflection angle of the fourth moving object relative to the view ray increases. The fourth moving object is a moving object whose capsule body area is in unique contact with the view ray in a virtual environment. The fourth moving object may be one of the first moving object, the second moving object, or a third moving object, or may be a moving object different from all of the first moving object, the second moving object, and the third moving object. This is not limited in this application.

The deflection angle of the fourth moving object relative to the view ray increasing is one of preconditions for enabling the speed feedback mechanism for the fourth moving object, and the precondition that the view ray contacts the capsule body area of the fourth moving object also may be satisfied for enabling the speed feedback mechanism for the fourth moving object.

In some embodiments, in a case that the deflection angle of the fourth moving object relative to the view ray decreases, a speed feedback mechanism for the fourth moving object is not enabled.

The speed feedback mechanism for the fourth moving object is enabled in a case that the deflection angle of the fourth moving object relative to the view ray increases, and the view ray may follow movement of the fourth moving object when the fourth moving object moves away from the view ray, to assist a user in aiming at a moving object, thereby increasing a success rate of aiming at the first moving object. The speed feedback mechanism for the fourth moving object is not enabled in a case that the deflection angle of the fourth moving object relative to the view ray decreases, thereby preventing the view ray from being pushed away from the fourth moving object in a speed direction of the fourth moving object when the fourth moving object approaches the view ray, and increasing the success rate of aiming at the first moving object.

In some embodiments, a first deflection angle vector is determined according to a first deflection angle of a fourth moving object relative to a view ray at a first moment, the first deflection angle vector being configured for representing a deflection angle and deflection direction for deflecting the view ray to the fourth moving object at the first moment. A second deflection angle vector is determined according to a second deflection angle of the fourth moving object relative to the view ray at a second moment, the second deflection angle vector being configured for representing a deflection angle and deflection direction of the view ray from the first moment to the second moment, and the second moment being a moment after the first moment; and the speed feedback mechanism for the fourth moving object is enabled in a case that a product of the first deflection angle vector and the second deflection angle vector is less than or equal to 0.

A size of the deflection angle of the fourth moving object relative to the view ray at the first moment is a deflection angle corresponding to the first deflection angle vector, and a deflection direction for deflecting the view ray to the fourth moving object at the first moment is a deflection direction corresponding to the first deflection angle vector.

From the first moment to the second moment, the size of the deflection angle of the fourth moving object relative to the view ray is a deflection angle corresponding to the second deflection angle vector, for example, a difference between the deflection angle of the fourth moving object relative to the view ray at the first moment and the deflection angle of the fourth moving object relative to the view ray at the second moment. A deflection direction of the fourth moving object from the first moment to the second moment is a deflection direction corresponding to the second deflection angle vector.

In a case that the product of the first deflection angle vector and the second deflection angle vector is less than or equal to 0, the deflection angle of the fourth moving object relative to the view ray increases, and the speed feedback mechanism for the fourth moving object is enabled. In a case that the product of the first deflection angle vector and the second deflection angle vector is greater than 0, the deflection angle of the fourth moving object relative to the view ray decreases, and the speed feedback mechanism for the fourth moving object is not enabled.

For example, the deflection direction corresponding to the first deflection angle vector is an x-axis direction in a two-dimensional rectangular coordinate system. If the deflection direction corresponding to the second deflection angle vector has a direction vector in a −x-axis direction in the two-dimensional rectangular coordinate system, the product of the first deflection angle vector and the second deflection angle vector is less than or equal to 0, and the speed feedback mechanism for the fourth moving object is enabled. If the deflection direction corresponding to the second deflection angle vector does not have a direction vector in a −x-axis direction in the two-dimensional rectangular coordinate system, but only has a direction vector in an x-axis direction on the two-dimensional rectangular coordinate system, the product of the first deflection angle vector and the second deflection angle vector is greater than 0, and the speed feedback mechanism for the fourth moving object is not enabled.

Conditions for enabling and disabling the speed feedback mechanism may alternatively apply to a case that the view ray is in contact with the first moving object and the third moving object.

By calculating the product of the first deflection angle vector and the second deflection angle vector, whether the deflection angle of the fourth moving object relative to the view ray increases can be quantitatively measured, thereby improving calculation efficiency of the computer device.

FIG. 8 shows content of a speed feedback mechanism, which mainly includes four aspects, which are respectively direction discrimination, dynamic intensity adjustment, identification of an intention of transferring a target, and anti-crosstalk during overlapping of a plurality of targets.

The direction discrimination refers to that a speed feedback mechanism for a moving object is not enabled in a case that the moving object approaches a view ray, and a speed feedback mechanism for a moving object is enabled in a case that the moving object moves away from a view ray. The dynamic intensity adjustment includes: dynamically adjusting a speed feedback intensity (a speed feedback coefficient) according to a distance between a first virtual object and a moving object, and dynamically adjusting the speed feedback intensity (the speed feedback coefficient) according to a deflection angle of the moving object relative to a view ray. The speed feedback coefficient has a positive correlation with the deflection angle, and has a negative correlation with the distance. The identification of the intention of transferring the target may refer to the schematic diagram shown in FIG. 7, which refers to temporarily blocking a moving object in a case that the moving object continuously moves away from the view ray and a deflection angle is greater than a first threshold. A speed feedback mechanism for the moving object is invalid within a blocking time. After the blocking time ends, or a speed feedback mechanism for another moving object is enabled, blocking for an original moving object is released. The anti-crosstalk during overlapping of a plurality of targets may refer to the schematic diagram shown in FIG. 6, which refers to that an unobstructed moving object is preferentially selected in a case that contour areas of the plurality of targets overlap, and a moving object with a smaller deflection angle is preferentially selected in a case that outer capsule bodies of the plurality of targets overlap.

The following describes apparatus embodiments of this application, which can be configured to perform the method embodiments of this application. Details not disclosed in the apparatus embodiments of this application refer to the method embodiments of this application.

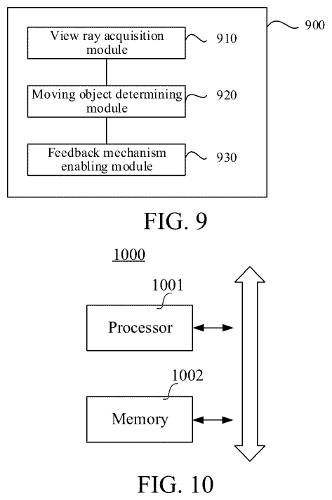

FIG. 9 is a block diagram of an apparatus for enabling a speed feedback mechanism according to some embodiments. The apparatus has a function of implementing the foregoing method for enabling a speed feedback mechanism. The function may be implemented by hardware, or may be implemented by hardware executing corresponding software. The apparatus may be a computer device described above, or may be arranged in the computer device. As shown in FIG. 9, an apparatus 900 may include: a view ray acquisition module 910, a moving object determining module 920, and a feedback mechanism enabling module 930.

The view ray acquisition module 910 is configured to acquire a view ray of a first virtual object located in a virtual environment, the view ray referring to an aiming baseline of an aiming item of the first virtual object.

The moving object determining module 920 is configured to determine, according to contact conditions between the view ray and a plurality of moving objects, a first moving object corresponding to the view ray from the plurality of moving objects.

The feedback mechanism enabling module 930 is configured to enable a speed feedback mechanism for the first moving object according to a contact condition between the view ray and the first moving object, the speed feedback mechanism referring to an auxiliary aiming mechanism that enables the view ray to follow the first moving object according to a movement speed of the first moving object.

In some embodiments, the moving object determining module 920 is configured to:
determine, in a case that the view ray is in contact with contour areas of the plurality of moving objects, a moving object of the plurality of moving objects that has a smallest distance to the first virtual object as the first moving object,
the contour area of the moving object referring to a three-dimensional space area corresponding to a body of the moving object.

In some embodiments, an outer capsule body is disposed around the moving object, and the moving object is located in the outer capsule body. The moving object determining module 920 is configured to:
determine, in a case that the view ray is in contact with the outer capsule bodies of the plurality of moving objects and not in contact with the contour area of any of the moving objects, a moving object of the plurality of moving objects that has a smallest deflection angle relative to the view ray as the first moving object,
the contour area of the moving object referring to a three-dimensional space area corresponding to a body of the moving object.

In some embodiments, the moving object determining module 920 is configured to:
acquire, for each of the plurality of moving objects, a ray pointing to the moving object from an endpoint of the view ray, to obtain a connecting ray corresponding to the moving object;
acquire a deflection angle of the moving object relative to the view ray according to an included angle between the view ray and the connecting ray corresponding to the moving object; and
determine the moving object that has the smallest deflection angle as the first moving object.

In some embodiments, an outer capsule body is disposed around the moving object, and the moving object is located in the outer capsule body. The moving object determining module 920 is configured to:
determine, in a case that the view ray is in contact with contour areas of a part of moving objects of the plurality of moving objects, and the view ray is in contact with outer capsule bodies of the other part of moving objects and not in contact with contour areas of the other part of moving objects, the first moving object from the part of moving objects,
the contour area of the moving object referring to a three-dimensional space area corresponding to a body of the moving object.

In some embodiments, the feedback mechanism enabling module 930 is configured to:
enable, in a case that the view ray is not in contact with an inner capsule body of the first moving object, a speed feedback mechanism for the first moving object, the inner capsule body being located in a contour area of the moving object, and the contour area of the moving object referring to the three-dimensional space area corresponding to the body of the moving object.

In some embodiments, the apparatus further includes a speed determining module. The speed determining module is configured to:
determine a speed feedback coefficient according to a deflection angle of the first moving object relative to the view ray and a distance between the first moving object and the first virtual object, the speed feedback coefficient referring to a ratio of a movement speed of the view ray to a movement speed of the first moving object, and the speed feedback coefficient having a positive correlation with the deflection angle and having a negative correlation with the distance; and
determine the movement speed of the view ray according to the speed feedback coefficient and the movement speed of the first moving object.

In some embodiments, the speed determining module is configured to:
determine, in a case that the deflection angle increases, the movement speed of the view ray according to the movement speed of the first moving object, the speed feedback coefficient, and an attenuation coefficient, the attenuation coefficient being a speed adjustment coefficient for a case that the deflection angle increases.

In some embodiments, the apparatus further includes a blocking module. The blocking module is configured to:
determine, in a case that the deflection angle of the first moving object relative to the view ray continuously increases until the deflection angle is greater than a first threshold, the first moving object as a blocking object, the blocking object being a moving object that the speed feedback mechanism is invalid within a blocking time.

In some embodiments, the blocking module is configured to:
release, in a case that the blocking time ends, blocking for the first moving object;
or
release, in a case that a speed feedback mechanism for a second moving object is enabled, blocking for the first moving object.

In some embodiments, a capsule body area is disposed around the moving object, and the capsule body area is a three-dimensional interlayer area between an inner capsule body and an outer capsule body; and the outer capsule body is a three-dimensional space area surrounding the inner capsule body, and the moving object is located in the outer capsule body.

The apparatus further includes a mechanism enabling module. The mechanism enabling module is configured to:
enable, in a case that the view ray is in contact with the capsule body area of a third moving object, a speed feedback mechanism for the third moving object.

In some embodiments, the apparatus further includes a mechanism disabling module. The mechanism disabling module is configured to:
disable, in a case that the view ray is in contact with the inner capsule body of the third moving object or not in contact with the outer capsule body of the third moving object, the speed feedback mechanism for the third moving object.

In some embodiments, the mechanism enabling module is further configured to:
enable, in a case that a deflection angle of a fourth moving object relative to the view ray increases, a speed feedback mechanism for the fourth moving object.

In some embodiments, the mechanism enabling module is further configured to:
determine a first deflection angle vector according to a first deflection angle of the fourth moving object relative to the view ray at a first moment, the first deflection angle vector being configured for representing a deflection angle and deflection direction for deflecting the view ray to the fourth moving object at the first moment;
determine a second deflection angle vector according to a second deflection angle of the fourth moving object relative to the view ray at a second moment, the second deflection angle vector being configured for representing a deflection angle and deflection direction of the view ray from the first moment to the second moment, and the second moment being a moment after the first moment; and
determine, in a case that a product of the first deflection angle vector and the second deflection angle vector is less than or equal to 0, that the deflection angle of the fourth moving object relative to the view ray increases, and enable the speed feedback mechanism for the fourth moving object.

In the technical solutions provided in some embodiments, the view ray of the first virtual object located in the virtual environment is acquired, and the first moving object corresponding to the view ray is determined from the plurality of moving objects according to the contact conditions between the view ray and the plurality of moving objects. Thus, for different contact conditions, a moving object that is more easily aimed at by the first virtual object may be selected in different selection manners, thereby avoiding crosstalk during overlapping of a plurality of targets, and increasing a success rate of aiming at the first moving object by a user. In addition, the speed feedback mechanism for the first moving object is enabled according to the contact condition between the view ray and the first moving object, whereby the view ray may move with the movement of the first moving object to assist the user in aiming at the first moving object, thereby improving a probability of aiming at the first moving object by the view ray, and further increasing the success rate of aiming at the first moving object by the user.

FIG. 10 is a structural block diagram of a computer device 1000 according to some embodiments. The computer device 1000 may be any electronic device having data computing, processing, and storage functions. The terminal device 1000 may be configured to implement the method for enabling a speed feedback mechanism provided in the foregoing embodiments.

Generally, the computer device 1000 includes a processor 1001 and a memory 1002.

The processor 1001 may include one or more processing cores, for example, a 4-core processor or an 8-core processor. The processor 1001 may be implemented in at least one hardware form among digital signal processor (DSP), a field programmable gate array (FPGA), and a programmable logic array (PLA). The processor 1001 may alternatively include a main processor and a coprocessor. The main processor is a processor configured to process data in an awake state, and is alternatively referred to as a central processing unit (CPU). The coprocessor is a low power consumption processor configured to process the data in a standby state. In some embodiments, the processor 1001 may be integrated with a graphics processing unit (GPU). The GPU is configured to render and draw content that may be displayed on a display screen. In some embodiments, the processor 1001 may alternatively include an AI processor. The AI processor is configured to process a computing operation related to machine learning.

The memory 1002 may include one or more computer-readable storage media. The computer-readable storage medium may be non-transitory. The memory 1002 may further include a high-speed random access memory and a nonvolatile memory, for example, one or more disk storage devices or flash storage devices. In some embodiments, the non-transitory computer-readable storage medium in the memory 1002 is configured to store a computer program. The computer program is configured to be executed by one or more processors to implement the foregoing method for enabling a speed feedback mechanism.

A person skilled in the art may understand that the structure shown in FIG. 10 does not constitute a limitation to the computer device 1000, more components or fewer components than those shown in the figure may be included, or some components may be combined, or a different component deployment may be used.

In an exemplary embodiment, a computer-readable storage medium is further provided. The storage medium has a computer program stored therein, and the computer program, when executed by a processor of a computer device, implements the foregoing method for enabling a speed feedback mechanism. In some embodiments, the foregoing computer-readable storage medium may be a read-only memory (ROM), a random access memory (RAM), a compact disc read-only memory (CD-ROM), a magnetic tape, a floppy disk, an optical data storage device, and the like.

In an exemplary embodiment, a computer program product is further provided. The computer program product includes a computer program, and the computer program is stored in a computer-readable storage medium. A processor of a computer device reads the computer program from the computer-readable storage medium, and the processor executes the computer program, to enable the computer device to perform the foregoing method for enabling a speed feedback mechanism.

In this application, before user-related data is collected and during collection of the user-related data, a prompt interface or a pop-up window can be displayed, or voice prompt information can be outputted. The prompt interface, the pop-up window, or the voice prompt information is configured for prompting the user that user-related data is currently being collected. In this way, in this application, related operations of acquiring the user-related data start to be performed only after a confirmation operation of the user on the prompt interface or the pop-up window is acquired. Otherwise (for example, when no confirmation operation of the user on the prompt interface or the pop-up window is acquired), the related operations of acquiring the user-related data are ended, for example, the user-related data is not to be acquired. In other words, all user data (including operation data of a user) collected in this application is strictly processed according to requirements of relevant national laws and regulations. The acquired personal information is collected with consent and authorization of the user within the scope of authorization of the laws and regulations and a subject of the personal information. Performing of subsequent data use and processing, and collection, use, and processing of the relevant user data may be needed to comply with relevant laws, regulations, and standards of relevant countries and regions.

What is claimed is:

1. A method for enabling a speed feedback mechanism, performed by a computer device, the method comprising:
acquiring a view ray of a first virtual object in a virtual environment, wherein the view ray includes an aiming baseline of an aiming item associated with the first virtual object;
determining, based on at least one contact condition between the view ray and a plurality of moving objects, a first moving object corresponding to the view ray from the plurality of moving objects; and
enabling a speed feedback mechanism for the first moving object based on a contact condition between the view ray and the first moving object,
wherein the speed feedback mechanism comprises an auxiliary aiming mechanism configured to adjust the view ray to follow the first moving object based on a movement speed of the first moving object.

2. The method according to claim 1, wherein the determining comprises:
determining, based on the view ray being in contact with contour areas of the plurality of moving objects, a moving object having a smallest distance to the first virtual object as the first moving object,
wherein each of the contour areas includes a three-dimensional space area corresponding to a body of the moving object.

3. The method according to claim 1, wherein each of the plurality of moving objects is surrounded by an outer capsule body; and
wherein the determining comprises:
determining, based on the view ray being in contact with outer capsule bodies of the plurality of moving objects and not in contact with a contour area of any moving object, a moving object of the plurality of moving objects having a smallest deflection angle relative to the view ray as the first moving object,
wherein the contour area of each of the plurality of moving objects comprises a three-dimensional space area corresponding to a body of a moving object.

4. The method according to claim 3, wherein the determining a moving object comprises:
acquiring, for each of the plurality of moving objects, a connecting ray from an endpoint of the view ray to the moving object;
acquiring a deflection angle of the moving object based on an included angle between the view ray and the connecting ray corresponding to the moving object; and
determining the moving object that has the smallest deflection angle as the first moving object.

5. The method according to claim 1, wherein each of the plurality of moving objects is surrounded by an outer capsule body, and
wherein the determining the first moving object comprises:
determining, based on the view ray being in contact with contour areas of a first group of the plurality of moving objects and outer capsule bodies of other group of the plurality of moving objects but not in contact with contour areas of the other group, the first moving object from the first group,
wherein each of the contour areas includes a three-dimensional space area corresponding to a body of a moving object.

6. The method according to claim 1, wherein the enabling a speed feedback mechanism comprises:
enabling, based on the view ray being not in contact with an inner capsule body of the first moving object, the speed feedback mechanism for the first moving object,
wherein the inner capsule body is in a contour area of the first moving object.

7. The method according to claim 1, further comprising:
determining a speed feedback coefficient based on a deflection angle of the first moving object relative to the view ray and a distance between the first moving object and the first virtual object,
wherein the speed feedback coefficient includes a ratio of a movement speed of the view ray to a movement speed of the first moving object,
wherein the speed feedback coefficient has a positive correlation with the deflection angle and having a negative correlation with the distance; and
determining the movement speed of the view ray based on the speed feedback coefficient and the movement speed of the first moving object.

8. The method according to claim 7, further comprising:
determining, based on the deflection angle increasing, the movement speed of the view ray based on the movement speed of the first moving object, the speed feedback coefficient, and an attenuation coefficient,
wherein the attenuation coefficient comprises a speed adjustment coefficient.

9. The method according to claim 7, further comprising:
determining, based on the deflection angle of the first moving object relative to the view ray continuously increasing until the deflection angle is greater than a first threshold, the first moving object as a blocking object,
wherein the blocking object includes a moving object for which the speed feedback mechanism is disabled within a blocking time period.

10. The method according to claim 9, further comprising at least one of:
releasing, based on the blocking time ending, blocking for the first moving object;
or
releasing, based on a speed feedback mechanism for a second moving object being enabled, blocking for the first moving object.

11. An apparatus for enabling a speed feedback mechanism, comprising:
at least one memory configured to store program code; and
at least one processor configured to read the program code and operate as instructed by the program code, the program code comprising:
acquiring code configured to cause at least one of the at least one processor to acquire a view ray of a first virtual object in a virtual environment, wherein the view ray includes an aiming baseline of an aiming item associated with the first virtual object;
determining code configured to cause at least one of the at least one processor to determine, based on at least one contact condition between the view ray and a plurality of moving objects, a first moving object corresponding to the view ray from the plurality of moving objects; and
enabling code configured to cause at least one of the at least one processor to enable a speed feedback mechanism for the first moving object based on a contact condition between the view ray and the first moving object,
wherein the speed feedback mechanism comprises an auxiliary aiming mechanism configured to adjust the view ray to follow the first moving object based on a movement speed of the first moving object.

12. The apparatus according to claim 11, wherein the determining code is further configured to cause at least one of the at least one processor to:
determine, based on the view ray being in contact with contour areas of the plurality of moving objects, a moving object having a smallest distance to the first virtual object as the first moving object,
wherein each of the contour areas includes a three-dimensional space area corresponding to a body of the moving object.

13. The apparatus according to claim 11, wherein each of the plurality of moving objects is surrounded by an outer capsule body; and
wherein the determining code is further configured to cause at least one of the at least one processor to:
determine, based on the view ray being in contact with outer capsule bodies of the plurality of moving objects and not in contact with a contour area of any moving object, a moving object of the plurality of moving objects having a smallest deflection angle relative to the view ray as the first moving object,
wherein the contour area of each of the plurality of moving objects comprises a three-dimensional space area corresponding to a body of a moving object.

14. The apparatus according to claim 13, wherein the determining code is further configured to cause at least one of the at least one processor to:
acquire, for each of the plurality of moving objects, a connecting ray from an endpoint of the view ray to the moving object;
acquire a deflection angle of the moving object based on an included angle between the view ray and the connecting ray corresponding to the moving object; and
determine the moving object that has the smallest deflection angle as the first moving object.

15. The apparatus according to claim 11, wherein each of the plurality of moving objects is surrounded by an outer capsule body, and
wherein the determining code is further configured to cause at least one of the at least one processor to:
determine, based on the view ray being in contact with contour areas of a first group of the plurality of moving objects and outer capsule bodies of other group of the plurality of moving objects but not in contact with contour areas of the other group, the first moving object from the first group,
wherein each of the contour areas includes a three-dimensional space area corresponding to a body of a moving object.

16. The apparatus according to claim 11, wherein the enabling code is further configured to cause at least one of the at least one processor to:
enable, based on the view ray being not in contact with an inner capsule body of the first moving object, the speed feedback mechanism for the first moving object,
wherein the inner capsule body is in a contour area of the first moving object.

17. The apparatus according to claim 11, wherein the program code further comprises:
coefficient code configured to cause at least one of the at least one processor to determine a speed feedback coefficient based on a deflection angle of the first moving object relative to the view ray and a distance between the first moving object and the first virtual object,
wherein the speed feedback coefficient includes a ratio of a movement speed of the view ray to a movement speed of the first moving object,
wherein the speed feedback coefficient has a positive correlation with the deflection angle and having a negative correlation with the distance; and
speed code configured to cause at least one of the at least one processor to determine the movement speed of the view ray based on the speed feedback coefficient and the movement speed of the first moving object.

18. The apparatus according to claim 17, wherein the speed code is further configured to cause at least one of the at least one processor to:
determine, based on the deflection angle increasing, the movement speed of the view ray based on the movement speed of the first moving object, the speed feedback coefficient, and an attenuation coefficient,
wherein the attenuation coefficient comprises a speed adjustment coefficient.

19. The apparatus according to claim 17, wherein the program code further comprises:
blocking code configured to cause at least one of the at least one processor to determine, based on the deflection angle of the first moving object relative to the view ray continuously increasing until the deflection angle is greater than a first threshold, the first moving object as a blocking object,
wherein the blocking object includes a moving object for which the speed feedback mechanism is disabled within a blocking time period.

20. A non-transitory computer-readable storage medium, storing computer code which, when executed by at least one processor, causes the at least one processor to at least:
acquire a view ray of a first virtual object in a virtual environment, wherein the view ray includes an aiming baseline of an aiming item associated with the first virtual object;
determine, based on at least one contact condition between the view ray and a plurality of moving objects, a first moving object corresponding to the view ray from the plurality of moving objects; and
enable a speed feedback mechanism for the first moving object based on a contact condition between the view ray and the first moving object,
wherein the speed feedback mechanism comprises an auxiliary aiming mechanism configured to adjust the view ray to follow the first moving object based on a movement speed of the first moving object.
